(19) United States
(12) Patent Application Publication
(10) Pub. No.: US 2010/0106725 A1
(43) Pub. Date: Apr. 29, 2010

(54) STORAGE APPLIANCE OBJECT ORIENTED SYSTEM AND METHOD

(75) Inventors: Randall K. Julian, JR., Zionsville, IN (US); Fred E. Lytle, Zionsville, IN (US)

Correspondence Address: BAKER & DANIELS LLP, 300 NORTH MERIDIAN STREET, SUITE 2700, INDIANAPOLIS, IN, 46204, US

(73) Assignee: Indigo BioSystems, Inc., Carmel, IN (US)

(21) Appl. No.: 12/605,124

(22) Filed: Oct. 23, 2009

Related U.S. Application Data
(60) Provisional application No. 61/108,270, filed on Oct. 24, 2008.

(51) Int. Cl. G06F 17/30

(52) U.S. Cl. 707/737; 707/769; 707/802; 707/E17.014; 707/E17.046

(57) ABSTRACT

The present invention involves a storage device system and method which receives and stores complex data. The storage device includes a bulk storage for storing the complex data, a descriptor storage for storing descriptive data relating to the complex data, and a service module with a processor and software. The software enables the processor to receive the complex data and derive descriptive data relating to the complex data. Further, the software also enables the processor to organize and store descriptive data in the descriptor storage. The storage device thus may receive the complex data, derive descriptive data relating to the complex data from the complex data, and organize and store the descriptive data.

### BACKGROUND OF THE INVENTION

1. Field of the Invention

The invention relates to data storage software. More specifically, the field of the invention is that of data storage software on complex data such as that of research data.

2. Description of the Related Art

The assignee of the present application has developed a system for managing data acquisition and storage from research organizations. As described in greater detail in copending U.S. patent application Ser. No. 11/441,263, filed on May 25, 2006, entitled ARCHIVAL DATA PROCESSING TO PROVIDE REPRODUCIBLE RESULTS, the disclosure of which is incorporated by reference herein, laboratory instruments and scientific desktop computers may be connected to high performance enterprise systems and services using existing servers, databases and storage systems. Such a system provides easy access to data while actively managing user security and data integrity. It is capable of automatically converting a range of proprietary data file formats into open, standard formats for visualization, data mining and long term access.

Using such a system, large amounts of data from multiple scientific instruments may be processed and analyzed for general and specific purposes. An illustrative example is the identification and measure of quantity of a specific chemical substance in a complex mixture such as blood. Chemical identification and quantitative analysis is often performed by complex instrumental methods of analysis, often with the assistance of computer controlling equipment. The exact configuration of the instrument and the state of a large number of parameters (voltages, settings, distances, etc.) must be fixed in order to conduct the measurement. The specific type and even make and model of instrument are also important to understanding the result produced by the device. These pieces of information are essential to the basic concept of the scientific method which is to allow another scientist to repeat the experiment and obtain comparable results. In addition to the state of the measurement device, the state, identity and details of the sample under consideration must also be known in order to draw inferences from the measurement. Everything from the history of the sample to the exact volume, amount or preparation of the sample affects the interpretation of the measurement results. Finally, the measurement itself can be any type of data from a single number (e.g. Temperature, weight), to a multidimensional or time-series measurement. The structure of the data, and the structure of the noise or error must be known to make sense of the raw numbers collected by modern instrumentation systems.

Simple text descriptions of experimental design, instrument design, instrument method and result data are often inadequate to allow a measurement to be interpreted, let alone repeated. Further, scientific literature-style descriptions are inherently difficult to interpret by machine. An added complication is that the modern measurement system requires a significant amount of storage to represent all of the information described above.

### SUMMARY OF THE INVENTION

The present invention is a complex data storage system and method which allows for the bulk storage of complex data in both a native form with engineered accessibility. In the operation of measurement systems to gain information on complex systems, it is often necessary to retain both un-interpreted measurement data along with a detailed description of the measurement process and the system being measured. The following describes an invention which provides both scalable storage of large volumes of measurement data, as well as an extensible representation of the measurement process and the system being measured. The present invention, in one aspect, provides a practical method to keep large volumes of un-interpreted data which allows the reuse and combination of multiple measurements to support the information needs of the scientific community.

The system disclosed in this application is constructed from three main components: a repository service module, a descriptor storage module, and a bulk data storage module. In combination, these modules provide a mechanism to store arbitrarily large measurement data objects, and describe them with an arbitrarily large number of properties and descriptors. These components may be embodied in a single appliance (device), or as software components distributed over multiple devices in a computer network.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of a storage appliance according to one embodiment of the present invention.

FIG. 2 is a node diagram representation of data relationships used in the operation of one embodiment of the present invention.

FIG. 3 is a node and property diagram representation of data relationships used in the operation of one embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Internet Explorer program sold by Microsoft Corporation (Internet Explorer is a trademark of Microsoft Corporation), the Opera Browser program created by Opera Software ASA, or the Firefox browser program distributed by the Mozilla Foundation (Firefox is a registered trademark of the Mozilla Foundation). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (“CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces.

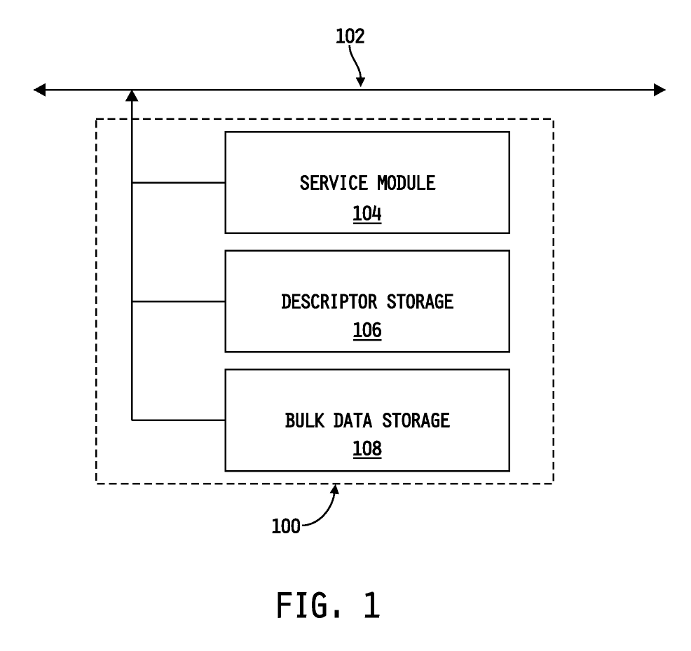

As depicted in FIG. 1, storage appliance system 100 is connected to a communications link 102, which may be in the form of an internal computer system bus, an ethernet cable, a WiFi wireless connection, or other embodiments of data communication. Storage appliance 100, in this exemplary embodiment, includes service module 104, descriptor storage 106, and bulk data storage 108, each of which is described in greater detail below.

Service module 104 of the exemplary embodiment provides end-user and administrative interfaces as well and programmatic interfaces for external software and hardware systems. Service module 104 further provides application-level user interfaces to affect user interaction with descriptor storage 106 and bulk data storage 108. In this exemplary embodiment, service module 104 provides user authentication and authorization services, data loading, data searching and data retrieval functions. It also provides an interface layer where various software and hardware communication protocols may be implemented to isolate other modules from variability in these technologies. Depending on the requirements, service module 104 may be configured with various levels of redundancy or hardening to ensure availability. Typically service module 104 is constructed from one or more server-type computers (computers that do not require direct human interfaces such as keyboards or displays) which are maintained via external communication interfaces. Service module 104 runs software specifically designed to support the interface needs of system 100. This is typically provided by some kind of internet-standards-based application container (a software application framework designed to execute and manage applications using internet protocols as their primary interface technology). There are many examples of web-enabled application containers (Apache Tomcat, Microsoft IIS, Sun Glassfish, The Spring Framework Container, etc.). The applications supported by these containers also vary and may include almost all modern computer languages. Depending on the type of application container used by service module 104, user identification and security may be provided either directly by the container, or implemented as a software module executing within the container.

Service module 104 provides a mechanism for end-users to deposit new bulk data items into the system along with the descriptions of that data and the measurement details (so-called “meta-data”). Service module 104 hides the details of the physical operation of descriptor storage module 106 and bulk storage module 108. Service module 104 may also ensure that data supplied to system 100 has maintained its content fidelity. Certain software applications communicating with service module 104 from outside system 100 may provide data and user identity and integrity information which may be verified by service module 104 prior to storage, and may confirm that the data has not changed while under its control when a data item is retrieved by the end-user. Service module 104 may optionally provide an interface which allows descriptors stored in descriptor module 106 to be searched and browsed such that data in bulk storage module 108 may be retrieved. Descriptors which reference data items in bulk storage module 108 may be used to request the retrieval of the data item. Further, service module 104 may optionally provide a mechanism for low-level queries to be executed on the actual content of data items in bulk storage module 108. Depending on the specific construction of bulk storage module 108, this may include distributing executable code to bulk storage module 108 to perform local query operations, or it may simply provide a mechanism for individual data items to be retrieved and queried within service module 104 itself.

Service module 104 further has the ability to confirm or deny operations performed or requested by a user based on the security role assigned to that user. End-users without permission to read a Descriptor, or a Bulk Data item, are denied permission and do not see these items on displays or have access to them via programmatic interfaces. Service module 104 records the time and date and other information about transactions and maintains records of operation and use of system 100, so that it may optionally provide administrators information about utilization, capacity, security and hardware/software execution status, errors and warnings.

Service module 104 obtains bulk data via communications link 102 which may or may not include descriptive information. Service module 104 may have intelligence, such as software or firmware, capable of deriving descriptive information from bulk data. One embodiment of the invention involves service module 104 identifying a mapping of the bulk data and using the predefined mapping to derive information about the contents of the bulk data. Another embodiment of the invention involves service module 104 having sophisticated programming logic so that the bulk data may be analyzed and characterized on a best fit basis or other heuristic algorithm to derive meta data information about the bulk data. As described below, if the data transmitter and system 100 have a common understanding of the format and expression of the meta data then such descriptive information is derived from the common understanding.

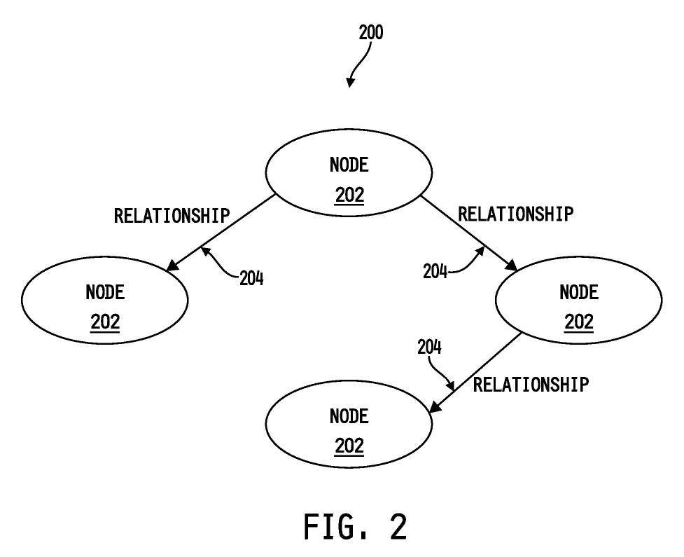

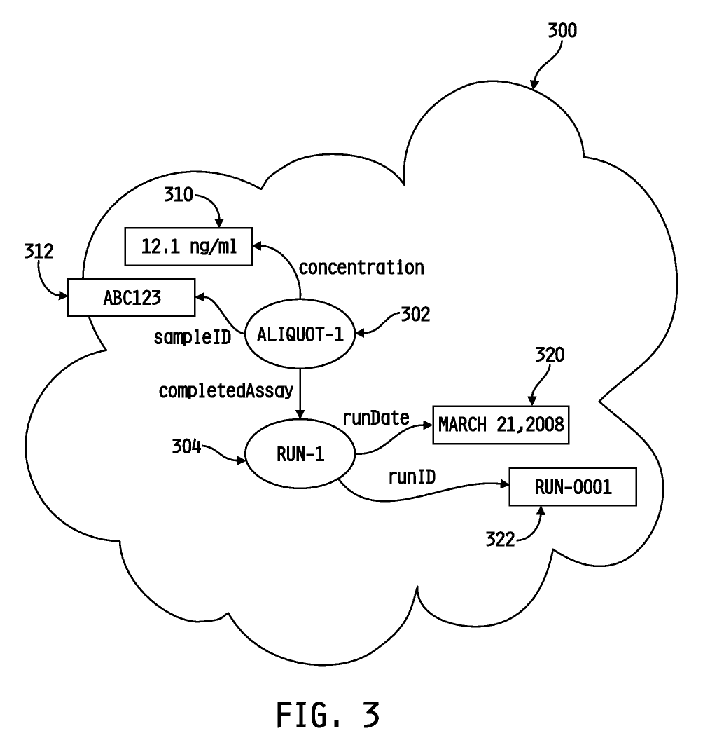

FIG. 2 shows a schematic representation for descriptions of all types that are represented as a directed acyclic graph 200 (DAG) where both vertices or nodes 202 and edges or links 204 of the graph may be named and may hold content. Vertices 202 are used as storage nodes holding either literal content, or a reference to content. Edges 204 of graph 200 are used to name relationships between the content represented by vertices 202. Graphs 200 may be checked for cyclical relationships since any such cycle implies that the content of a particular node 202 is ultimately described via a series of relationships in terms of itself Beyond this simple restriction, imposed by logic, DAGs 200 are a powerful mechanism for describing concepts and physical objects. Routinely the relationship being named by an edge 204 is to call one node a “property” of another. A use of this approach for the illustrative example of chemical analysis graph 300 may be represented by the schematic diagram shown in FIG. 3.

In FIG. 3, a item called “Aliquot-1” 302 has two literal properties: “sampleID” 310 and “concentration” 312, the literal value of the sampleID of Aliquot-1 is “ABC123”. “Aliquot-1” also has a relationship with another item called “Run-1” 304. The relationship “completedAssay” 330 is used to infer the following: “Aliquot-1” 302 has “completedAssay” 330 whose name is “Run-1” 304. The direction of the arrow 330 in schematics such as FIG. 3 are used to indicate which item is the subject and which is the object. The relationship, therefore, acts as a predicate in a semantic construct: “Subject”, “Predicate”, and “Object”.

A DAG may be broken down into a collection of Subject, Predicate, and Object—3-tuple statements. Known as “Triples” these statements are complete sentences which may be interpreted by computer hardware and software.

DAGs are so useful for representing knowledge in a machine compatible fashion, that several standard methods for representing them have been established. These standards make it possible to develop software to read and write semantic triples in an efficient and interoperable way. Standard syntax for writing and reading a triple is the first of a two step process to ensure a machine may properly interpret a DAG. The second step is standardizing the names and definitions of the nodes and relationships. A standard set of node and relationship names is known as a controlled vocabulary. Controlled vocabularies ensure that a common understanding for every name in the DAG may be achieved by different interpreters. An additional constraint may be imposed to ensure the validity of a description in the form of specifying that a specific node type is only allowed to have specific relationships. By specifying the controlled vocabulary and constraining valid relationships, a DAG may be used to represent an ontology.

By creating and maintaining an ontology for the specific types of experiments, measurements, samples and results within a field of research, a scientist may thus describe any activity within the laboratory. Descriptor module 106 includes an implementation of such an ontology and its ontology instances. Descriptor module 106 provides storage and retrieval of semantic triple statements and supports queries which may return either instance members of the ontology, or a subset of the ontology (schema) itself. An exemplary embodiment uses a current standard for semantic triple statement representation such as the World Wide Web Consortium's (W3C) Resource Descriptor Framework (RDF). For an RDF implementation, there are a range of query languages and interface tools which may be implemented. An example of a query language would be the W3C Data Access Group “SPARQL” specification. Other query languages would also be possible depending on the implementation of descriptor module 106.

Descriptor module 106 may also include a triple statement loading mechanism. This may be implemented in several ways, from reading triple statements from a simple file system to creating data streams directly into the system. Additionally, query languages may be combined with such a loading mechanism which support insert, update and delete actions.

An exemplary embodiment addresses query performance for realistic situations encountered in research activities. System 100 may use vertical partitioning of semantic triples to spread information over multiple relational database tables. This allows for the use of a standard database engine for the storage of the components of the triple, and thus allows the Standard Query Language (SQL) to be used in addition to semantic-specific query languages. Vertical partitioning involves the automatic translation of predicates into tables and the storage of subjects and objects as elements in the table. In most vertical partition implementations, additional information is stored with the subject and object, including language and a unique identifier. While no limit on the type of database is implied, some database designs have more favorable characteristics than others. A database with a limited number of tables necessarily limits the number of predicates allowed in the ontology. A database which stores columns sequentially on the physical media allows for object or subject searches to occur via sequential reads of storage device. For some applications, the entire ontology may be stored in memory and provide significant performance gains over disk-based implementations. The design of the overall architecture of system 100, therefore, does not depend on any specific data base implementation within descriptor module 106.

Bulk storage module 108 represents a storage device for complex data. For example, chemical and biological measurements performed by instrumental methods of analysis create an array of data items which hold everything from instrumental setup and experimental parameters to raw measurements and results. Some fraction of this overall information set is represented as descriptors and stored in descriptor storage module 106 in the form of DAGs as described above. Typically, the majority of information generated by instruments is stored as a bulk data set referenced by descriptors. Such descriptors may be used to identify and select data sets for further investigation, and to do so then reference or point to data objects in bulk storage module 108 of system 100. In addition, such descriptors may also provide information about the nature of the data in bulk storage module 108 to facilitate further processing on other computers.

In one embodiment of system 100, bulk storage module 108 represents a file-based or object-based data storage subsystem including some form of large scale storage such as disk drives or solid state storage. Because every laboratory implementation is different, there are no restrictions on the type of bulk storage used, or its scale.

Bulk storage module 108 is capable of storing and retrieving data objects sent via commands issued from service module 104. Some type of hardware interface is therefore required between service module 104 and bulk storage module 108, however there are no restrictions on the design, or protocol of this connection. Several embodiments of bulk storage module 108 include dedicated hard drives connected via internal bus systems in the server controlling either service module 104 or descriptor storage module 106. Bulk storage module 108 may also be implemented as a network-based storage subsystem (Network Attached Storage, or a Storage Area Network) or a specialized storage appliance.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A storage device for receiving and storing complex data, said storage device comprising:
a bulk storage capable of storing the complex data;
a descriptor storage capable of storing descriptive data relating to the complex data, said descriptor data including references to the related complex data in said bulk storage; and
a service module coupled to said bulk storage and said descriptor storage, said service module including a processor and software enabling said processor to receive the complex data and derive descriptive data relating to the complex data, said software further enabling said processor to organize and store said descriptive data in said descriptor storage; and said software further enabling said processor to retrieve the complex data based on a query of the descriptive data.

2. The storage device of claim 1 wherein said service module includes software with an ontology detection module enabling said processor to classify the complex data according to a predefined ontology.

3. The storage device of claim 2 wherein said service module includes software enabling said processor to store descriptive data in said descriptor storage in accordance with a determined onocology.

4. The storage device of claim 3 wherein said descriptive data is organized into a triple statement for storage in said descriptor storage.

5. The storage device of claim 1 wherein said service module includes a query engine for performing queries on said descriptor storage.

6. The storage device of claim 5 wherein said service module is adapted to retrieve data from said bulk storage associated with a descriptive data identified by said query engine.

7. Using a computer, a method of storing complex data, said method comprising the steps of:
receiving the complex data and storing the complex data in bulk storage;
deriving descriptive data relating to the complex data from the complex data, the descriptor data including references to related complex data in the bulk storage; and
organizing and storing said descriptive data.

8. The method of claim 7 wherein said deriving step includes classifying the complex data according to a predefined ontology.

9. The method of claim 8 wherein said classifying step includes creating descriptive data in accordance with a determined onocology.

10. The method of claim 9 wherein said classifying step involves organizing the descriptive data into a triple statement for storage.

11. The method of claim 7 further comprising the step of storing the complex data locally.

12. The method of claim 7 further comprising the step of performing a query on said descriptive data.

13. The method of claim 12 further comprising the step of retrieving the complex data associated with descriptive data identified in said query step.

14. A machine-readable program storage device having stored encoded instructions for a method of storing complex data, said method comprising the steps of:
receiving the complex data and storing the complex data in bulk storage;
deriving descriptive data relating to the complex data from the complex data, the descriptor data including references to related complex data in the bulk storage; and
organizing and storing said descriptive data.

15. The machine-readable program storage device of claim 14 wherein said deriving step of said method includes classifying the complex data according to a predefined ontology.

16. The machine-readable program storage device of claim 15 wherein said classifying step of said method includes creating descriptive data in accordance with a determined onocology.

17. The machine-readable program storage device of claim 16 wherein said classifying step of said method involves organizing the descriptive data into a triple statement for storage.

18. The machine-readable program storage device of claim 14 wherein said method further comprises the step of storing the complex data locally.

19. The machine-readable program storage device of claim 14 wherein said method further comprises the step of performing a query on said descriptive data.

20. The machine-readable program storage device of claim 19 wherein said method further comprises the step of retrieving the complex data associated with descriptive data identified in said query step.
